(19) United States
(12) Patent Application Publication
(10) Pub. No.: US 2004/0017106 A1
(43) Pub. Date: Jan. 29, 2004

(54) Automatic braking apparatus generating braking force in accordance with driving condition of driver

(76) Inventors: Hiroaki Aizawa, Anjo-city (JP); Shinsuke Sakane, Handa-city (JP); Yuzo Imoto, Chita-gun (JP); Masashi Kishimoto, Chiryu-city (JP)

Correspondence Address: POSZ & BETHARDS, PLC, 11250 ROGER BACON DRIVE, SUITE 10, RESTON, VA, 20190, US

(21) Appl. No.: 10/463,877

(22) Filed: Jun. 18, 2003

(30) Foreign Application Priority Data
Jun. 19, 2002 (JP) 2002-178712

(51) Int. Cl. B60T 8/32

(52) U.S. Cl. 303/191

(57) ABSTRACT

A brake control ECU of an automatic braking apparatus calculates an awareness level in accordance with: whether or not there are a braking pedal or accelerator pedal operations; whether or not there are shift and steering wheel operations; and whether a level of a driver's eye movement lowers. When the brake control ECU determines that the awareness level has decreased, it controls the hydraulic braking apparatus so as to increase a provision braking force applied for a certain period and with a certain cycle to each wheel 4FR, 4FL, 4RR, 4RL. Accordingly, vibration caused by increase and decrease of the braking force is generated in a body of a vehicle that is running. This vibration arouses the driver whose level of consciousness has decreased.

### CROSS REFERENCE TO RELATED APPLICATION

This application is based upon and claims the benefit of Japanese Patent Application No. 2002-178712 filed on Jun. 19, 2002, the content of which are incorporated herein by reference.

### FIELD OF THE INVENTION

The present invention relates to a vehicular automatic braking apparatus. More particularly, the present invention relates to an apparatus that controls awakening of a driver and stopping of the vehicle in a case where a level of consciousness of the driver is decreased.

### RELATED ART OF THE INVENTION

In a conventional automatic braking apparatus, when drowsiness of a driver is detected, a buzzer warning is executed to the driver, or a stimulus is applied to the driver in order to awaken the driver. The automatic braking apparatus also flashes hazard lights and executes automatic braking to stop a vehicle (Japanese Patent Publication Laid-Open No. 7-32995).

However, the automatic braking apparatus has difficulty in reliably awakening the driver using the buzzer warning. Meanwhile, means for awakening the driver, for example, means for applying minute current to a driver seat, means for suddenly increasing in a volume of noise generated by an audio apparatus, and means for decreasing temperature in a cabin by an air conditioner, are used in some cases. In each of the above cases, however, because a dedicated apparatus is required, cost for the braking apparatus is increased.

In view of the foregoing situation, it is an object of the present invention to reliably awaken the driver when the driver cannot focus attention on driving due to a decreased level of consciousness or the like, without providing a dedicated apparatus.

### SUMMARY OF THE INVENTION

In view of the foregoing situation, it is an object of the present invention to reliably awaken the driver when the driver cannot focus attention on driving due to a decreased level of consciousness or the like, without providing a dedicated apparatus.

An automatic braking apparatus according to the present invention repeatedly increases and decreases a provided braking force to each wheel of a vehicle under a certain provision condition, when a detected awareness level is low. This repetition of increase and decrease of the braking force generates vibration in a vehicle body. Accordingly, the vibration of the vehicle body awakens the driver without a dedicated apparatus.

### BRIEF DESCRIPTION OF THE DRAWINGS

Other objects, features and advantages of the present invention will be understood more fully from the following detailed description made with reference to the accompanying drawings. In the drawings:

FIG. 1 is a schematical view showing an automatic braking apparatus according to a first embodiment of the present invention;

FIG. 2 is a schematical view showing a hydraulic braking apparatus of the automatic braking apparatus according to the first embodiment;

FIG. 3 is a flow chart of a main routine that is executed in the automatic braking apparatus according to the first embodiment;

FIG. 4 is a flow chart of a routine that is executed in an automatic braking control according to the first embodiment;

FIG. 5 is a flow chart of a routine that is executed in an awakening determination according to the first embodiment;

FIG. 6 is a flow chart of a first half of a routine that is executed in an awakening braking mode according to the first embodiment;

FIG. 7 is a flow chart of a second half of the routine that is executed in the awakening braking mode according to the first embodiment;

FIG. 8 is a flow chart of a routine that is executed in an automatic vehicle stop mode according to the first embodiment;

FIG. 9 is a time diagram showing an operation process of the automatic braking apparatus according to the first embodiment;

FIG. 10 is a flow chart of a second half of a routine that is executed in an awakening braking mode according to a second embodiment of the present invention;

FIGS. 11A to 11D show correction coefficient characteristics that correct a provision condition of awakening braking in the awakening braking mode; and

FIG. 12 is a time diagram showing an operation process of an automatic braking apparatus according to modification of the present invention.

### DETAILED DESCRIPTION OF THE PREFERRED EMBODIMENTS

The present invention will be described further with reference to various embodiments in the drawings.

### First embodiment

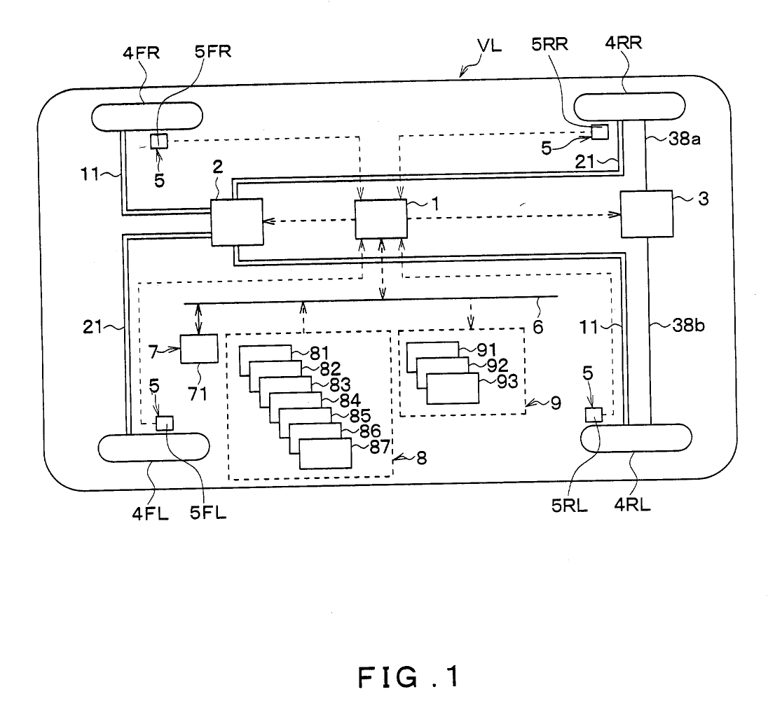

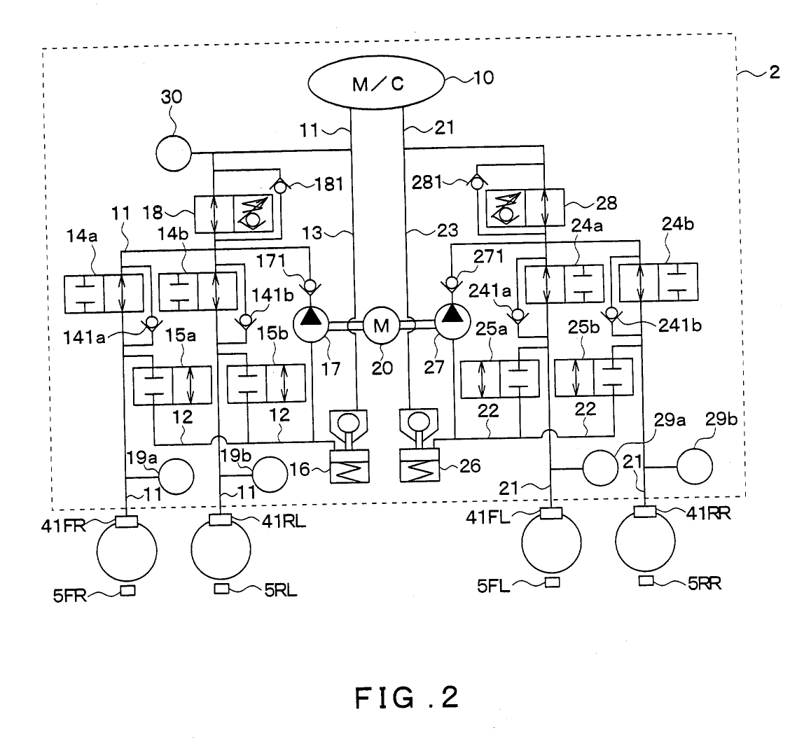

An automatic braking apparatus according to a first embodiment of the present invention will be explained with reference to the drawings. FIG. 1 is a schematical view showing an automatic braking apparatus according to a first embodiment, and FIG. 2 is a schematical view showing a hydraulic braking apparatus of FIG. 1. Reference symbols FR, FL, RR, and RL denote a front-right wheel, a front-left wheel, a rear-right wheel, and a rear-left wheel of a vehicle VL, respectively.

Structural elements of the automatic braking apparatus as described in the first embodiment are mounted on the vehicle VL. The automatic braking apparatus includes a brake control ECU 1 as a control device, a hydraulic braking apparatus 2 as a first braking device, an electric parking brake (hereinafter referred to as “PKB”) 3, and wheel cylinders 41FR, 41RL, 41FL and 41RR (hereinafter each of which is referred to as “W/C”). The W/Cs 41FR, 41RL, 41FL and 41RR are provided for wheels 4FR, 4RL, 4FL, and 4RR, respectively, and respective sets of the two W/Cs are diagonally connected to the hydraulic braking apparatus 2 via a first brake circuit 11 and a second brake circuit 21. Braking wires 38a and 38b are disposed between the PKB 3 and the rear wheels 4RL and 4RR, and connect the PKB 3 with a brake caliper for each of the rear wheels 4RL and 4PR.

Moreover, the automatic braking apparatus includes wheel speed sensors 5 for detecting a rotational speed of each wheel, an on-board LAN bus 6 for transmitting respective input/output signals of various electronic devices, an inter-vehicle distance control ECU 71, which controls an interval between the vehicle VL and another vehicle in front, as a braking request output portion 7, a group of sensors 8, and an actuator portion 9.

The group of sensors 8 includes sensors that detect a driving operation state such as a lateral acceleration sensor 81, a steering angle sensor 82, a shift position sensor 83, a brake pedal sensor 84, and an accelerator pedal sensor 85; a driver's eye sensor 86 that detects a driver's eye of the driver; and an inter-vehicle distance sensor 87 that detects a relative speed of a forward vehicle and a distance therefrom. The steering angle sensor 82, the shift position sensor 83, the brake pedal sensor 84, and the accelerator pedal sensor 85, the driver's eye sensor 86 and the brake control ECU 1 constitute an awareness level detection portion.

The actuator portion 9 includes a lamp and alarm apparatus 91 including various lamps such as a hazard lamp, and a warning apparatus such as abuser; an emergency locking retractor 92; and a door lock actuator 93.

Specific details of the structural elements of the automatic braking apparatus are described as follows.

The brake control ECU 1 is constituted by a computer. Wheel speeds from the wheel speed sensors 5, a braking request from the braking request output portion 7 via the on-board LAN bus 6, and sensor signals from the group of sensors 8 are input to the brake control ECU 1. Then the braking control ECU 1 outputs driving signals for controlling the hydraulic braking apparatus 2 and the PKB 3 and an operation signal for operating the actuator portion 9.

The PKB 3 functions to maintain a stopped state of a vehicle, when the vehicle is stopped. Specifically, the PKB 3 is operated by a driving signal from the brake control ECU 1. The PKB 3 moves the braking wires 38a and 38b so as to press the brake calipers with a friction member for the rear-right and rear-left wheels 4RR and 4RL against respective brake discs, respectively, and thereby braking force is generated.

Even when the driving signal from the brake control ECU 1 is canceled, the PKB 3 does not release the movement of the braking wires 38a and 38b. Accordingly, a stopping of the vehicle is maintained. The stopping state of the vehicle is maintained, until a driving signal (i.e., a cancel signal) is output from the brake control ECU 1, or until a driving signal (i.e., a cancel signal) is output by pressing of a cancel switch, (not shown), by the driver.

The wheel speed sensors 5 include sensors 5FR, 5RL, 5FL, and 5RR that are provided for each wheel for detecting a rotational speed of each wheel. A rotational speed signal for each wheel from the wheel sensors 5 is directly input to the brake control ECU 1. The brake control ECU 1 computes a vehicle speed based on the rotational speed signal, i.e., the wheel speed, and executes ABS control and traction control based on the wheel speed and the vehicle speed.

The inter-vehicle distance control ECU 71 that acts as the braking request output portion 7 executes driving control based on engine output control, and executes braking control and transmission control based on braking apparatus control. The inter-vehicle distance control ECU 71 controls the vehicle speed of the vehicle VL based on a relative speed of the vehicle in front of the vehicle VL and the vehicle VL detected by the inter-vehicle distance sensor. The vehicle speed is controlled such that the inter-vehicle distance from the vehicle in front of the vehicle VL is equal to a target value that is predetermined or a target value that can be set by the driver, when the vehicle VL is running at or more than a certain speed. According to the first embodiment, a braking control signal corresponding to a target braking distance as the braking request is output from the vehicle inter-vehicle distance ECU 71 to the brake control ECU 1 via the on-board LAN bus 6.

Based on this output, the brake control ECU 1 determines a target deceleration from the present vehicle speed and the target braking distance. The target deceleration is converted to a brake pressure (brake fluid pressure) based on, for example, the Equation: Deceleration 1 G=10 MPa (Pa: Unit of pressure, Pascal), and then converted into a target braking force. Driving signals for the hydraulic braking apparatus 2 and the PKB 3 are determined based on the target braking force. Note that Pa refers to Pascal indicating a unit of pressure, and corresponds to a W/C pressure. Since W/C pressure for 1 MPa corresponds to deceleration of 0.1 G (gravitational acceleration), the equation above is established.

The group of sensors 8 outputs a signal to the brake control ECU 1 via the on-board LAN bus 6. Sensors that constitute the group of sensors 8 are as follows.

The lateral acceleration sensor 81 that detects a lateral acceleration that is generated on the vehicle while it is running, and outputs a detection signal in accordance with the detected lateral acceleration.

The steering angle sensor 82 that detects a steering angle of a steering wheel, (not shown), and outputs a detection signal in accordance with the detected steering angle.

The shift position sensor 83 that outputs a detection signal related to positional information (P, R, N, D, D1, and the like) of a transmission lever, (not shown). In an automatic braking control when the driver is awaken according to the first embodiment, this information is used particularly when the position D (drive) to which the lever is set during normal driving is changed to another lever position.

When a brake pedal and an accelerator pedal, not shown, are respectively depressed by the driver, the brake pedal sensor 84 and the accelerator pedal sensor 85 detect respective pedal stroke amounts of the brake pedal and the accelerator pedal. Next, detection signals are output in accordance with the pedal stroke amounts. Further, when the respective pedal strokes exceed predetermined amounts, respectively, the brake pedal sensor 84 and the accelerator pedal sensor 85 output ON signals indicating this information.

The steering angle sensor 82, the shift position sensor 83, the brake pedal sensor 84, and the accelerator pedal sensor 85 detect a driving operation state of the driver, and more specifically, whether or not a driving operation is detected.

The driver's eye sensor 86 includes an infrared light source and an image processing device provided in the vicinity of a driver's seat of the vehicle VL so as to detect the driver's eye. In the detection method, first, the image processing device takes an image of the face of the driver, to which infrared light beams are radiated at a certain time interval, and then captures this image. Next, the image processing device detects a driver's eye direction of the driver from the image of the face, and outputs an ON-signal to the on-board LAN bus 6 when a change amount of an angle of the driver's eye direction exceeds a threshold value after a predetermined time has elapsed.

Note that a detection method of a driver's eye in which an iris of an eye is detected (Japanese Patent Publication Laid-Open No. 4-225478), a detection method in which a reflected image from illuminated light of an eyeball is detected, or the like, may be used as the method for detecting the driver's eye in the image processing device.

The lamp and alarm apparatus 91 includes the buzzer and a warning light which are within the vehicle, and the hazard lamp, which is outside the vehicle. The buzzer outside the vehicle and the warning lamp are provided in order to enhance a driver awakening effect. Further, the hazard lamp outside the vehicle is operated when stopping or maintaining a stopped state of the vehicle in order to inform other vehicles of the abnormal condition of the vehicle, when the vehicle enters an automatic vehicle stop mode since an awareness level of the driver is regarded as insufficient. The buzzer and the hazard lamp are operated by the brake control ECU 1 in the awakening braking mode for awakening a driver during an automatic braking control. They are operated at the same time as the braking force of the hydraulic braking apparatus 2 is increased and decreased.

The emergency locking retractor (ELR) 92 locks a seat belt based on a signal from the brake control ECU 1, when the vehicle enters the automatic vehicle stop mode, at the same time as the hazard lamp is turned on.

The door lock actuator 93 releases door locks of the vehicle based on a signal from the brake control ECU 1, when the vehicle is in the automatic vehicle stop mode and enters a vehicle stop maintenance state.

Next, a structure and an operation of the hydraulic braking apparatus 2 which acts as a first braking portion will be now explained. FIG. 2 shows the structure of the hydraulic braking apparatus 2.

A master cylinder (hereinafter referred to as “M/C”) 10 generates an M/C pressure in accordance with a pedal depression force when the brake pedal, not shown, is depressed by the driver. The M/C pressure is supplied to the W/Cs 41FR and 41RL via the first brake circuit 11, and to the W/Cs 41FL and 41RR via the second brake circuit 21 so as to generate first braking force. Hereafter, an explanation will be given of the first brake circuit 11, and in particular, a brake circuit related to the front-right wheel 4FR. However, the same explanation also applies to the other wheels and the second brake circuit.

In the first brake circuit 11, pressure increase control valves 14a and 14b are provided in the front-right wheel 4FR and the rear-left wheel RL, respectively. The pressure increase control valves 14a and 14b adjust a pressure increase and pressure maintenance for the W/Cs 41FR and 41RL, respectively, in an anti-skid control (hereinafter referred to as “ABS control”). Check valves 141a and 141b are provided in parallel with the pressure increase control valves 14a and 14b, respectively. Accordingly, a fluid flow is released to a side of the M/C 10, when the W/C pressure becomes excessive during the pressure increase valves 14a and 14b are closed. Meanwhile, pressure decrease control valves 15a and 15b are provided in a pressure decrease conduit 12 that extends from a point between the pressure increase control valves 14a and 14b and the W/Cs 41FR and 41RL. The pressure decrease control valves 15a and 15b adjust pressure decrease and pressure maintenance of the W/Cs 41FR and 41RL in the ABS control.

The pressure decrease conduit 12 is connected to a reservoir 16. The reservoir 16 has a brake fluid accommodation function and check valve function. A brake fluid stored in the reservoir 16 is pumped up by a pump 17 which is driven by a motor 20 and is discharged to the first brake circuit 11. The brake fluid is discharged between the pressure increase control valves 14a and 14b and a cut-off valve (herein after referred to as “SM valve”) 18. The motor 20 also drives a pump 27 disposed in the second brake circuit 21. The motor 20 that drives the pumps 17 and 27 is operated by an operation signal from the brake control ECU 1. A check valve 171 is provided at a discharge port of the pump 17.

The SM valve 18 is disposed between the M/C 10 and the pressure increase control valves 14a and 14b. The SM valve 18 is a two position valve. When de-energized it is in a opened state, and when energized it is in a closed state that is closed by a check valve in a direction shown in the drawing. In the closed state, when a pressure at a side of the W/Cs 41FR and 41RL becomes higher than a pressure at the side of the M/C 10 by a pressure equivalent to a component of pressure generated by a spring of the check valve 18, the pressure is released. A check valve 181 is positioned in parallel with the SM valve 18, and the check valve 181 only allows flow from the side of the M/C 10 to the side of the W/Cs 41FR and 41RL.

An intake conduit 13 connects between the reservoir 16 and a point between the M/C 10 and the SM valve 18.

A fluid pressure sensor 30 is provided for detecting a pressure generated in the M/C 10 between the M/C 10 and the SM valve 18 in the first brake circuit 11. The pressure that the fluid pressure sensor 30 detects is a pressure generated in a secondary chamber, not shown, of the M/C 10. However, an amount equivalent to the pressure is also generated in the primary chamber to which the second brake circuit 21 is connected. Accordingly, the fluid pressure sensor 30 detects, in effect, the M/C pressure. Further, fluid pressure sensors 19a and 19b, for detecting each W/C pressure, are also provided between the pressure increase control valves 14a and 14b and the W/Cs 41FR and 41RL. Output signals from the fluid pressure sensors 19a and 19b are compared with the requested braking force applied by the brake control ECU 1. Based on this comparison result, a braking control is executed in each mode.

The aforementioned pressure increase control valves 14a and 14b and the pressure decrease control valves 15a and 15b are two position valves. When de-energized (when OFF), that is, when the brake pedal is not operated, when normal braking is executed, or the like, valve body positions of the valves are as shown in the drawing. Namely, the pressure increase control valves 14 and 14b are in an opened state and the pressure decrease control valves 15a and 15b are in a closed state. Further, a valve body position of the SM valve 18 is also as shown in the drawing, i.e., in the opened state. Each control valve is operated by an operation signal from the brake control ECU 1.

Next, a basic control method of the hydraulic braking apparatus 2 will be explained.

In a normal braking operation when the brake pedal is depressed by the driver, all control valves (the SM valve 18, the pressure increase control valves 14a and 14b, and the pressure decrease control valves 15a and 15b) are in a de-energized (OFF) state. Thus, the M/C pressure directly acts on the W/Cs 41FR to 41FL, and therefore, the W/C pressure is equal to the M/C pressure.

During the ABS control, different operations are executed for a process in which the W/C pressure is decreased for avoiding tire lock; and a process in which the W/C pressure is increased to recover the braking force. The SM valve 18 is normally OFF (i.e., in the opened state) during the ABS control.

During the pressure decrease process of the ABS control, the pressure increase control valve 14a is in the energized (ON) state, that is, in the closed state. On the other hand, ON/OFF duty ratio control is executed for the pressure decrease control valve 15a such that switching between opened state and closed state is repeated. Accordingly, brake fluid starts flowing from the W/C 41FR to the reservoir 16, at a certain gradient of change, and thereby the W/C pressure decreases.

During the pressure increase process of the ABS control, the pressure decrease control valve 15a is in the de-energized (OFF) state, that is, in the closed state. Further, the OFF/ON duty ratio control is executed for the pressure increase control valve 14a such that switching between opened state and closed state is repeated. Accordingly, brake fluid is supplied from the M/C 10 to the W/C 41FR, and thereby the W/C pressure increases.

Next, the automatic braking control according to the present invention will be explained. The automatic braking control herein refers to the pressure increase process and the pressure decrease process in which increase and decrease of the braking force are executed irrespective of whether the operation of depressing the brake pedal occurs. This control will be explained with reference to a front-right wheel 41FR as an example. Note that both the pressure increase process and the pressure decrease process of the automatic braking control are also executed in the awakening braking mode. In the awakening braking mode, the braking force is repeatedly increased and decreased by the hydraulic braking apparatus 2 in order to awaken the driver. On the other hand, only the pressure increase process is executed in the automatic vehicle stop mode in which the vehicle is automatically decelerated and stopped when a state in which driving is impossible for the driver (hereinafter referred to as a “driving impossible state.”)

In the pressure increase process of the automatic braking control, the SM valve 18 is turned ON (i.e., is placed in the closed state) and the pressure decrease control valve 15a is turned OFF (i.e., is placed in the closed state). Next, the pump 17 is driven to suck up and discharge the brake fluid through the reservoir 16. In this state where the discharge pressure is being generated by the pump 17, the discharge pressure is compared with the detected value by the fluid pressure sensor 19a, and the OFF/ON duty ratio control is executed for the pressure increase control valve 14a. Accordingly, the W/C pressure is increased at a certain gradient of change or until it reaches a predetermined target pressure. At this time, the brake fluid may be replenished from the M/C 10 to the intake port of the pump 17 via the intake conduit 13 and the reservoir 16.

In the pressure decrease process of the automatic braking control, the SM valve 18 is turned ON (i.e., is placed in the closed state) and the pressure increase control valve 14a is turned ON (i.e., is placed in the closed state). Next, the pump 17 is driven to suck up and discharge the brake fluid through the reservoir 16. In a state where the discharge pressure is being generated by the pump 17, the discharge pressure is compared with the detected value by the fluid pressure sensor 19a, and at the same time, ON/OFF duty ratio control is executed for the pressure decrease control valve 15a. Accordingly, the brake fluid is sucked up by the W/C 41FR, and thus, the W/C pressure is decreased at a certain gradient of change or until it reaches a predetermined target pressure. At this time, since both the increase control valve 14a and the SM valve 18 are closed, the discharge pressure of the pump 17 increases. However, when this discharge pressure becomes larger than the component of pressure of the spring of the check valve of the SM valve 18, the pressure is released and thereby decreased.

Each of other wheels is operated by an operation signal from the brake control ECU 1 in a similar manner to above. In other words, in each wheel, controls for both the pressure increase process and the pressure decrease process are executed in a state where the SM valves 18 and 28 are ON (i.e., in the closed state), and the pumps 17 and 27 are driven. For the rear-left wheel 41RL, the pressure decrease control valve 15b is OFF (i.e., in the closed state), and the pressure increase control valve 14b is subject to the OFF/ON duty ratio control in the pressure increase process. On the other hand, the pressure increase control valve 14b is ON (i.e., in the closed state), and the pressure decrease control valve 15b is subject to the ON/OFF duty ratio control in the pressure decrease process.

For the front-left wheel 41FL, the pressure decrease control valve 25a is OFF (i.e., in the closed state), and the pressure increase control valve 24a is subject to the OFF/ON duty ratio control in the pressure increase process. On the other hand, the pressure increase control valve 24a is ON (i.e., in the closed state), and the pressure decrease control valve 25a is subject to the ON/OFF duty ratio control in the pressure decrease process.

Further, for the rear-right wheel 41RR, the pressure decrease control valve 25b is OFF (i.e., in the closed state), and the pressure increase control valve 24b is subject to the OFF/ON duty ratio control in the pressure increase process. On the other hand, the pressure increase control valve 24b is ON (i.e., in the closed state), and the pressure decrease control valve 25b is subject to the ON/OFF duty ratio control in the pressure decrease process.

In the automatic braking control according to the first embodiment, the W/C pressure for each wheel of the vehicle VL is increased and decreased. The W/C pressure for each wheel may be increased and decreased independently. Alternatively, the W/C pressures for an appropriate set of two wheels may be simultaneously increased and decreased. Or, the W/C pressures for all four wheels may be increased and decreased simultaneously. Accordingly, it is possible to generate or decrease a braking force for each wheel.

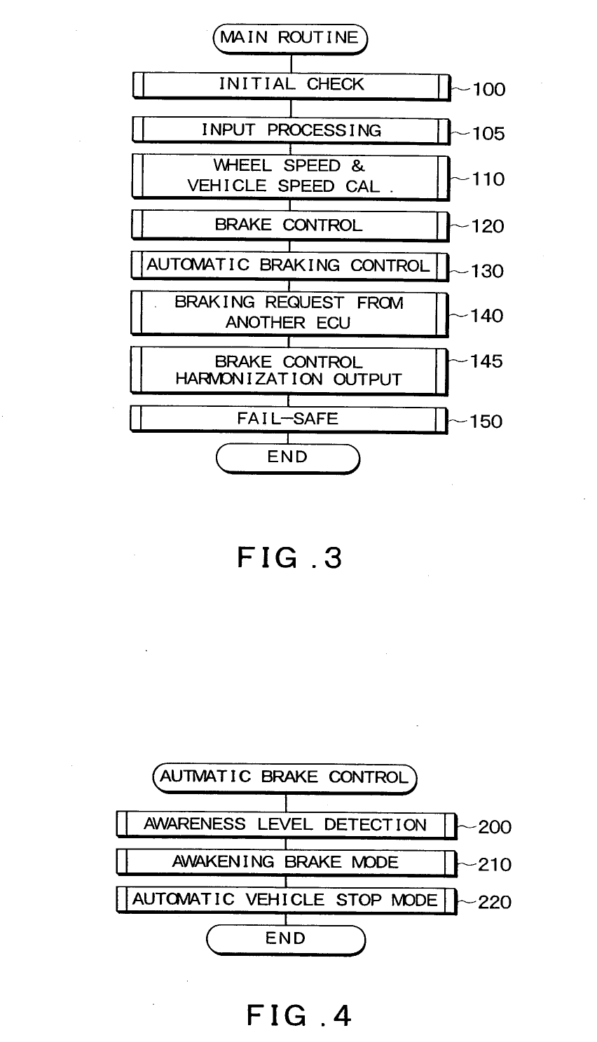

Next, a processing procedure for the automatic braking control executed by the brake control ECU 1 according to the first embodiment will be explained. FIG. 3 is a schematical view showing a flow chart of a main routine of the procedure.

The brake control ECU 1 starts processing at a time point when an ignition is turned ON. At 100, an initial check is executed. During the initial check, operation of each actuator for the hydraulic braking apparatus 2 and the PKB 3 are checked. The hydraulic braking apparatus 2 identifies any portion that has a breakdown or abnormality. For example, the hydraulic braking apparatus 2 checks for any broken wires of solenoid valves (14a, 14b, 24a, 24b, 15a, 15b, 25a, 25b, 18 and 28) by supplying a current to each solenoid valve and checking each terminal voltage at the brake control ECU 1. Also, the hydraulic braking apparatus 2 may determine that a brake fluid pressure is abnormal based on detected values of the fluid pressure sensors 30, 19a, 19b, 29a and 29b.

Moreover, the PKB 3 identifies a location of the breakdown or abnormality by determining, for example, whether the detected current when energized is normal, or whether the motor for driving the brake wires 38a and 38b is rotating normally. Moreover, the system is configured to take appropriate actions such that no abnormal operation is performed by each member in the brake apparatus 2, when the breakdown or abnormality is detected. These actions include prohibiting a specific control, switching to an alternative control, and turning on a hazard lamp, and the like, after the breakdown or abnormality is detected.

Next various types of input processing are executed at 105. Information from the vehicle speed sensors 5, the group of sensors 8, such as the lateral acceleration sensor 81 and the like, and the inter-vehicle distance control ECU 71 are obtained.

At 110, a wheel speed for each of the wheels 4FR, 4FL, 4RR and 4RL is obtained from the detected value of each of the wheel speed sensor 5, and a vehicle speed is calculated based on each wheel speed.

At 120, a brake control in accordance with a driving condition of a vehicle VL is executed. Specifically, brake assist control, anti-lock brake (ABS) control, traction control, and side slip prevention control are executed. The brake assist control increases the M/C pressure when the depression amount of the brake pedal is large. The ABS control inhibits slipping of the wheels when the wheel speed becomes lower than the vehicle speed when the vehicle is being stopped and a slip ratio equals to a certain amount or more, so as to obtain adequate braking force. The traction control controls an engine output and braking force when the wheel speed becomes larger than the vehicle speed and the slip ratio equals to a certain amount or more, so as to decrease slippage. The side slip prevention control controls the braking force for each wheel so as to ensure the stability of the vehicle body based on the lateral acceleration and the yaw rate of the vehicle.

At 130, an awareness level of the driver is detected based on the outputs from the group of sensors 8, and the automatic braking control is executed based on this detected value. In other words, the braking control in order to awaken the driver, and the automatic vehicle stop control for stopping the vehicle VL safely when the driver is not awakened even after the abovementioned braking control has been executed, are executed.

At 140, braking operation is performed based on a braking request from another control system ECU such as the inter-vehicle distance control ECU 71.

At 145, each of the brake control request is harmonized and output to the hydraulic braking apparatus 2 and the PKB 3.

At 150, fail safe check is executed during the ignition is ON. In other words, states of the brake control ECU 1, the hydraulic braking apparatus 2, the PKB 3, and the other sensors 81 to 87 are constantly diagnosed. When the breakdown or abnormality is detected, predetermined action is performed such that the vehicle VL does not enter an unsafe state.

Next, a flow of the automatic braking control at 130 according to the first embodiment will be explained with reference to FIG. 4.

At 200, an awareness state of the driver is detected by calculated the awareness level of the driver. This calculation of the awareness level starts at a time point when the ignition is turned ON, and repeated certain interval of time until the ignition is turned OFF.

At 210, the awakening braking mode is initiated in which a method of providing braking force on the vehicle VL is selected based on the calculated awareness level. Subsequently, the awakening braking mode is executed.

At 220, the automatic vehicle stop mode is initiated in which the vehicle VL is automatically stopped when a state in which driver's capability is reduced is not solved at 210.

Hereafter details of the respective processing at 200 to 220 will be explained.

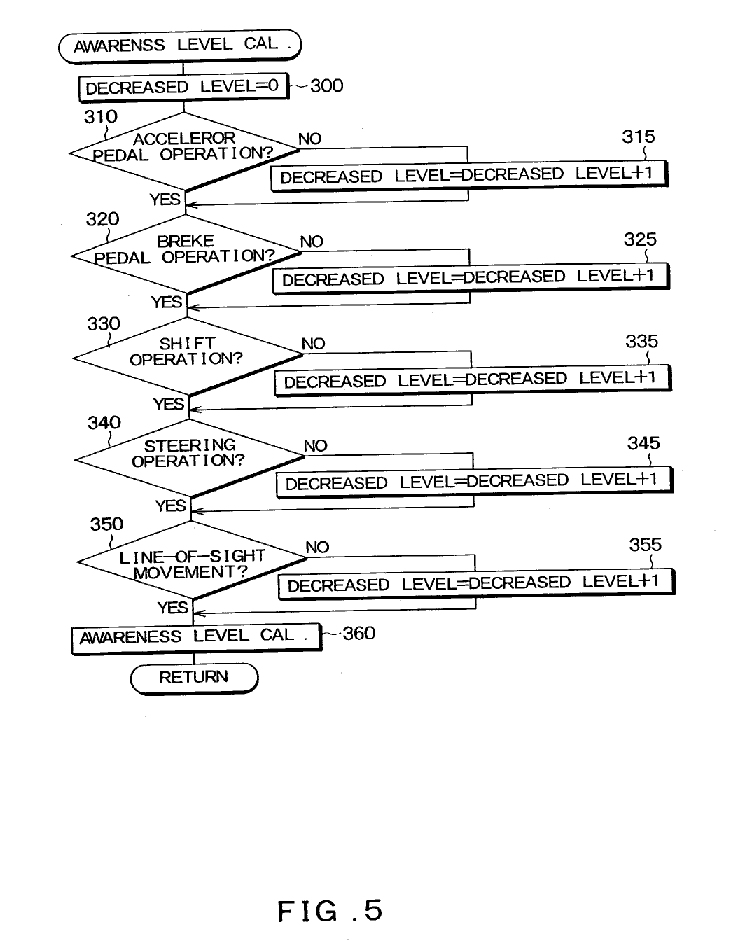

FIG. 5 is a flow chart showing calculation and detection of the awareness level at 200. The routine in this flowchart is repeatedly executed at a certain determination interval (for example, every 5 seconds).

At 300, a decreased level of consciousness counter is reset to zero. At 310, it is determined whether or not there is an ON signal from the accelerator pedal sensor 85 (or an accelerator pedal stroke amount signal with a certain amount or more) within a certain time period. That is, it is determined whether or not there is an accelerator operation within the certain time period. If there is, the routine proceeds to 320. If there is not, the decreased level of consciousness counter is incremented by one at 315, and the routine proceeds to 320.

At 320, it is determined whether there is an ON signal from the brake pedal sensor 84 (or a brake pedal stroke amount signal with a certain amount or more) within a certain time period after the brake pedal 84 is operated. That is, it is determined whether there is a brake operation within the certain time period. If there is, the routine proceeds to 330. If there is not, the decreased level of consciousness counter is incremented by one at 325, and the routine proceeds to 330.

At 330, it is determined whether there is a signal that indicates a change of position from the shift position sensor 83 within a certain time period. That is, it is determined whether there is a shift operation within the certain time period. If there is, the routine proceeds to 340. If there is not, the decreased level of consciousness counter is incremented by one at 335, and the routine proceeds to 340.

At 340, it is determined whether there is a steering angle signal from the steering angle sensor 86 within a certain time period. That is, it is determined whether there is a steering wheel operation within the certain time period. If there is, the routine proceeds to 350. If there is not, the decreased level of consciousness counter is incremented by one at 345, and the routine proceeds to 350.

At 350, it is determined whether there is an ON signal from the driver's eye sensor 83 within a certain time period. That is, it is determined whether there is the time movement of the driver's eye within the certain time period. If there is, the routine proceeds to 360. If there is not, the decreased level of consciousness counter is incremented by one at 355, and the routine proceeds to 360.

At 360, an awareness level is calculated based on the decreased level of consciousness counter level using Expression 1.

Awareness level (%)=100×(5-Decreased level of consciousness counter value)/5 (1)

That is, the awareness level as calculated above indicates an occurrence frequency of the driving operation and the movement of the driver's eye within the determination period. Smaller values (the minimum value=0) indicate that the awareness level is lower and that the driver 's level of consciousness is low. Accordingly, it is indicated that the driver has entered a state in which driving is impossible. As mentioned above, at 300 to 360, together with the group of sensors 8, constitute the awareness level detection portion.

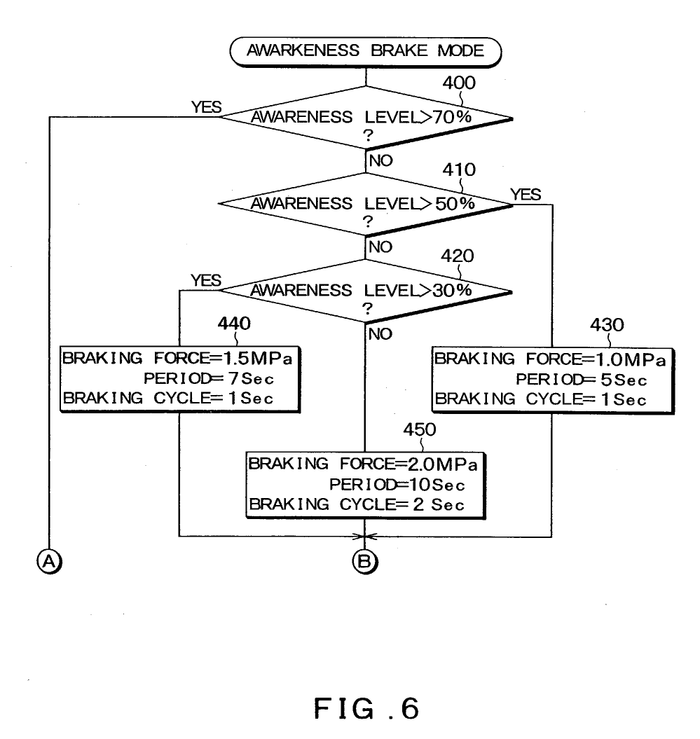

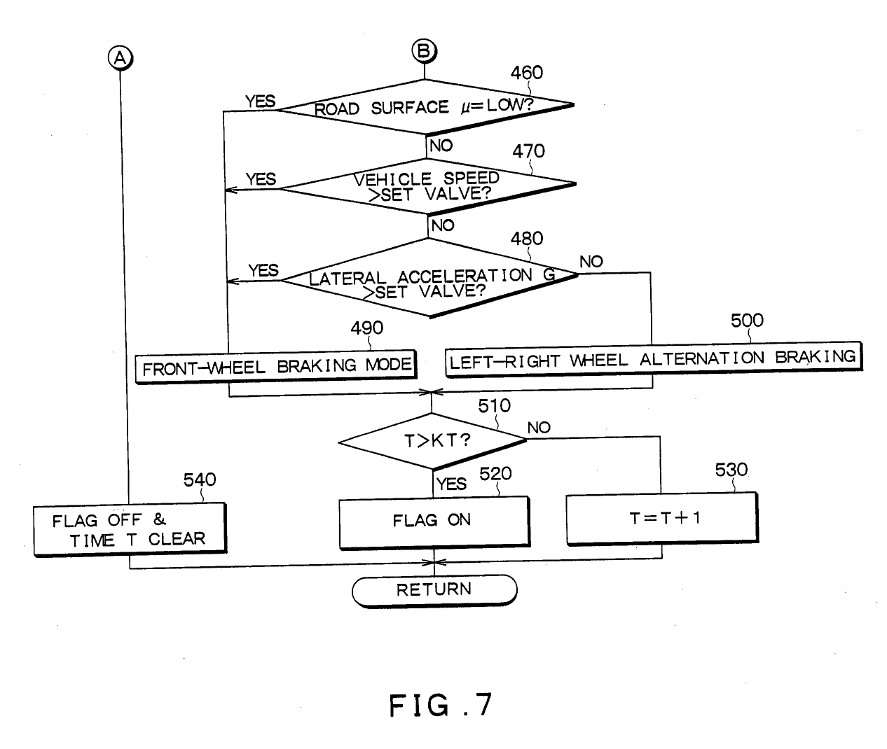

FIGS. 6 and 7 are flowcharts of the awakening braking mode at 210.

At 400, whether or not the awareness level calculated by Expression 1 exceeds 70% is determined. If a determination is YES, the routine proceeds to 540. If the determination is NO, the routine proceeds to 410.

At 410, whether or not the awareness level exceeds 50% is determined. If a determination is YES, the routine proceeds to 430. If the determination is NO, it proceeds to 420.

At 420, whether or not the awakeness level exceeds 30% is determined. If a determination is YES, the routine proceeds to 440. If the determination is NO, it proceeds to 450.

As mentioned above, processing from 430 to 450 changes braking force provision conditions in accordance with the magnitude of the awareness level.

At 430, when the awareness level is medium, that is, when the awareness level is in the range of 50<awareness level ≦70, a braking force in accordance with the awareness level is generated at each wheel. For example, the following conditions may be set as braking force provision conditions: the provision braking force is 1.0 MPa; the provision period KT is 5 seconds; the braking cycle is 1 second. That is, a cycle for increasing and decreasing the braking force which is executed every second is set such that the braking force is increased from 0 to 1 MPa during the initial 0.5 second, and then decreased from 1 to 0 MPa in the latter 0.5 second (that is, a triangle time waveform is obtained.) In this case, the cycle for increasing and decreasing the braking force is repeated five times in the 5 seconds of the provision period KT.

At 440, when the awareness level is low, that is, when the awareness level is in the range of 30< awareness level ≦50, a braking force in accordance with the awareness level is generated at each wheel. For example, following conditions are set as braking force provision conditions: the provision braking force is 1.5 MPa; the provision period KT is 7 seconds; the braking cycle is 1 second. Compared to the case at 430, the provision braking force is set higher. Further, the provision period KT is set longer such that the number of repetitions is increased to 7. Accordingly, a driver awakening effect is enhanced.

At 450, when the awareness level is at a minimum, that is, when the awareness level is in the range of awareness level ≦30, a braking force in accordance with the awareness level is generated at each wheel. For example, following conditions are set as braking force provision conditions: the provision braking force is 2.0 MPa; the provision period KT is 10 seconds; the braking cycle is 2 seconds. Compared to the cases at 430 and 440, the provision braking force is set higher, and the provision period KT is set longer. Therefore, the driver is more strongly stimulated to awaken. Moreover, since the braking cycle is set longer, that is, the increase and decrease of the braking force is executed relatively slowly and in a large magnitude, the awakening effect is further enhanced.

After the braking force provision conditions in the awakening braking mode have been selected, it is determined at 460 whether or not a road friction coefficient (road surface μ), which is one of the pieces of information that indicates the driving state, is smaller than a predetermined set value. In other words, it is determined whether or not μ is low, which indicates that the road is slippery. If a determination is YES, the routine proceeds to 490. If the determination is NO result, the routine proceeds to 470.

The road surface μ is calculated by the brake control ECU 1 based on the wheel speeds, by a method, for example, as disclosed in Japanese Patent Publication Laid-Open No. 2000-55790.

At 470, it is determined whether or not the vehicle speed, which is one of the pieces of information indicating the driving state, is larger than a predetermined set value. If a determination is YES, the routine proceeds to 490. If the determination is NO, the routine proceeds to 480.

At 480, it is determined whether or not a lateral acceleration α, which is detected by the lateral acceleration sensor 81 and is one of the pieces of information indicating the driving state, is larger than a predetermined set value. If a determination is YES, in other words, if the vehicle is presently turning sharply, the routine proceeds to 490. If the determination is NO, in other words, if the vehicle is running straight or turning relatively mildly, the routine proceeds to 500.

At 480, a turning radius R, in place of the lateral acceleration, may alternatively be used as one of the pieces of information indicating the driving state. This is because, if it is assumed that α is a lateral acceleration (a detected value) and v is a vehicle speed (a detected value or a calculated value obtained from the wheel speed detection value), the turning radius R may be calculated from R=v×v/α. Therefore, it is possible to determine whether the vehicle is turning sharply or not by determining whether the calculated turning radius R is smaller than a predetermined set value, as in the case of determining sharp turning using the lateral acceleration.

Each piece of the information indicating the driving state, namely, the vehicle speed, the road μ, and the turning radius R, is calculated by the brake control ECU 1. The lateral acceleration is detected by the lateral acceleration sensor 81. The processing of calculation and detection of the aforementioned information indicating the driving state corresponds to a driving state detection portion according to the present invention.

At 490, a front-wheel braking mode is executed, if the detected driving state satisfies a condition of being at least one of: a slippery road; driving at a relatively high speed; and executing a sharp turn. Specifically, braking is executed simultaneously on only the two front wheels 41FR and 41FL under the braking force provision condition selected from 430 to 450.

On the contrary, when none of the conditions of processing from 460 to 480 are satisfied, braking in order to awaken the driver is executed on the right and left wheels alternately at 500. Specifically, at first, increase and decrease of the braking force corresponding to a braking cycle is simultaneously executed on only the two right wheels 41FR and 41RR. Next, increase and decrease of braking force corresponding to a braking cycle is simultaneously executed for only the two left wheels 41FL and 41RL. As described above, two braking cycles are combined as a set, and increase and decrease of the braking force is executed for the two right wheels and for the two left wheels, alternately.

This imbalance braking between left and right provides the vehicle body with a vibration which is different from a normal case. In other words, this braking provides the driver with a sense of discomfort which is unexpected, and thus, this enhances the driver awakening effect. However, with consideration of safety driving when executing the imbalance braking between left and right, the imbalance braking is executed only when the vehicle is running straight or turning a gentle curve at a relatively low speed on a high μ road. External disturbances during above mentioned periods are less prone to have an effect.

Next, at 510, it is determined whether or not an operation continuation time T in the awakening braking mode exceeds the provision period KT which was determined from 430 to 450. If the operation continuation time T does not exceed the provision period KT, a counter value of the operation continuation time T is increased, and the routine returns to 400.

On the contrary, if the operation continuation time T exceeds the provision time KT, a driving impossible state flag is turned ON at 520, and the routine moves into the automatic stop mode.

Further, if it is determined that the awareness level is high, that is, awareness level >70%, the driving impossible state flag is turned OFF and the operation continuation time T in the awakening braking mode is cleared (i.e., reset to zero) at 540. Next, the routine returns to 400, and the routine above is repeated.

Note that the routine described from 400 to 530 as described above is repeated based on the awareness level which is computed at every certain time period. Therefore, if the awareness level increases and exceeds 70% before the operation continuation time T has reached the provision time KT, the routine proceeds from 400 to 540. Accordingly, the awakening braking mode is completed. Therefore, in a case where the awareness level of the driver increases immediately after the operation of the awakening braking mode is started (in other words, before the provision time is completed), it is possible to complete the awakening braking mode at that time. On the other hand, when the awareness level decreases (to 70% or less), it is possible to start the operation of the awakening braking mode immediately. Accordingly, the first embodiment allows quick operation of the awakening brake in order to awaken the driver in response to the change in the awareness level of the driver.

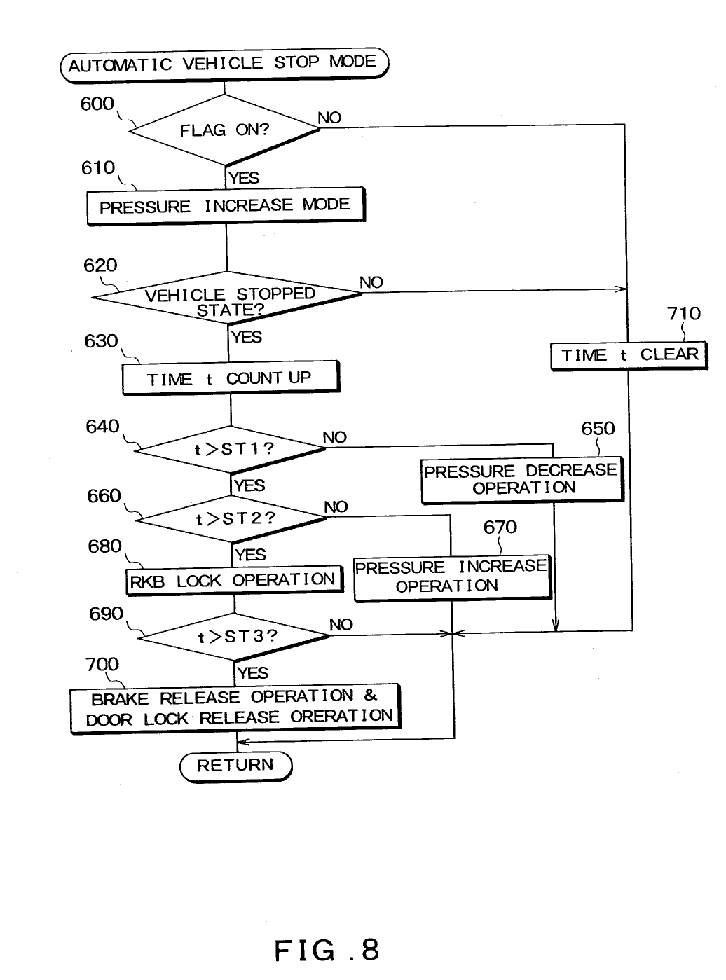

Next, an automatic vehicle stop mode at 220 will be explained. FIG. 8 is a flow chart of the automatic vehicle stop mode.

At 600, it is determined whether or not the driving impossible state flag is ON. If the determination NO, the routine proceeds to 710 where an elapsed time t, which is defined an interval from a time period at which the vehicle VL is stopped to present, is reset. If a determination is YES, the routine returns to 610.

At 610, a pressure increase control is executed on the hydraulic braking apparatus 2 in order to decelerate and stop the vehicle VL. In other words, the pressure increase process is performed, in which: the pumps 17 and 27 are driven, the SM valves 18 and 28 and the pressure decrease control valves 15a, 15b, 25a and 25b are closed, and the ON/OFF duty ratio control of the pressure increase control valves 14a, 14b, 24a and 24b is executed. Thus the W/C pressure is generated.

At the same time, the hazard lamp is flashed to execute a warning to people outside of the vehicle, and a request for locking is output to the ELR 92 in order to secure the driver in the seat. Further, an emergency communication is performed via a communication device to the police, the fire station, the emergency service, the road administrators, and the like, that are outside the vehicle.

At 620, based on signals from the wheel sensors 5, the stopped state of the vehicle VL is determined by whether or not the vehicle speed has become 0.2 m/sec or less. If the determination is NO, the routine proceeds to 710. If the determination is YES, the routine proceeds to 630.

At 630, the elapsed time t is counted up. Next, at 640, it is determined whether or not the elapsed time t exceeds a first elapsed time ST1 (for example, 0.8 seconds). If the determination is NO at 650, the hydraulic braking apparatus 2 is driven so as to decrease the pressure and the routine returns to 600. If a determination is YES, the routine proceeds to 660.

At 660, it is determined whether or not the elapsed time t exceeds a second elapsed time ST2 (for example, 1.3 seconds). If the determination is NO, the hydraulic braking apparatus 2 is driven to increase the pressure at 670, and the routine returns to 600. If a determination is YES, the routine proceeds to 680.

At 680, a driving signal is output from the brake control ECU 1 so as to lock the PKB 3.

At 690, it is determined whether or not the elapsed time t exceeds a third elapsed time ST2 (for example, 4.3 seconds). If the determination is NO, the routine returns to 600. If a determination is YES, the routine proceeds to 700.

At 700, driving of the hydraulic braking apparatus 2 and the PKB 3 is canceled. Specifically, the pumps 17 and 27 are stopped, all solenoid valves (the SM valves 18 and 28, the increased control valves 14a, 14b, 24a and 24b, the pressure decrease control valves 15a, 15b, 25a and 25b) are de-energized so as to release each W/C pressure. The driving signal for the PKB 3 is also cancelled. Even though the driving signal for the PKB 3 is canceled, the braking force thereon is maintained, and the stopped state of the vehicle VL is maintained. Further, at the same time, the door lock actuator 93 releases door locks and completes the automatic vehicle stop mode.

Processing from 640 to 700 correspond to a shock reduction portion. The purpose of the processing is to execute so called shock-free vehicle stopping during a time period from a time point at which the vehicle the elapsed time t=0 to a time point at which the vehicle stopped condition is maintained. In other words, during a time period at which the elapsed time t is from zero to ST1, the hydraulic braking apparatus 2 is driven to decrease the pressure in accordance with the pressure decrease process of the automatic braking control. Thereby, the braking force is decreased. On the other hand, during a time period at which the elapsed time t is from ST1 to ST2, the hydraulic braking apparatus 2 is driven so as to increase the pressure in accordance with the pressure increase process of the automatic braking control. Thereby the braking force increases.

When the elapsed time t exceeds ST2, the PKB 3 is operated at the same time so as to generate braking force. Further, when the elapsed time exceeds ST3 and the vehicle VL is completely stopped, the braking force applied by the hydraulic braking apparatus 2 is released, and the vehicle stopped condition is maintained only by the braking force applied by the PKB 3. Moreover, release of the door locks after the vehicle is stopped enables emergency action to be conducted more easily from outside of the vehicle (such as first aid for the driver).

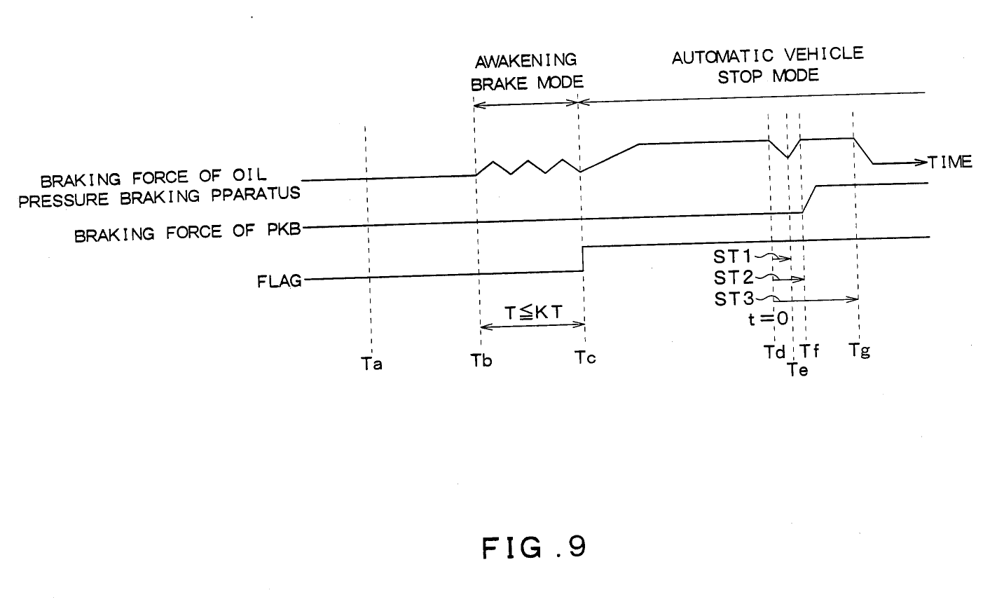

FIG. 9 is a time diagram showing how execution of the awakening breaking mode and the automatic vehicle stop mode in the automatic braking control according to the first embodiment changes the state in which the vehicle VL is running and is stopped.

During running, when the driver stops driving operation at a time point Ta due to a reason such as losing consciousness, the awareness level decreases. The awareness level is constantly detected (processing from 300 to 360). If it is determined that the awareness level has decreased to 70% or less at a time point Tb (processing from 400 to 420), the awakening braking mode is started (processing at 460 and 530).

During the awakening braking mode, the cyclic increase and decrease of the braking force for each wheel is executed based on the braking force provision condition which is selected in accordance with the awareness level (processing from 430 to 450). The cyclic increase and decreases is continued until a time point Tc as shown in the drawing, with the maximum provision time being set as KT. During this period, an intermittent vibration is provided to the vehicle body to awaken the driver.

If the awareness level of the driver does not recover to a high level (i.e., 70% or more) even after the provision period KT is completed at the time point Tc, the driving impossible state flag is turned ON (at 520). The routine proceeds to the automatic vehicle stop mode.

When the automatic vehicle stop mode is started, the hydraulic braking apparatus 2 is driven to increase the pressure. Therefore, the braking force increases to a given value at which the vehicle can be slowly decelerated at a certain gradient. At the same time, a warning is performed to other vehicles by flashing a hazard lamp, and the driver is secured in the seat by locking the seat belt. Further, an emergency communication is executed using the communication device to the police, emergency center, and the like, that are outside the vehicle (at 610).

When it is determined that the vehicle is in a stopped state at a time point Td (at 620), counting-up of the elapsed time t is started. The hydraulic braking apparatus 2 is driven to decrease the pressure at a certain gradient until a time point Te when the elapsed time t reaches the first elapsed time ST1. Then, the hydraulic braking apparatus 2 is driven to increase the pressure so as to restore the braking force, from after the elapsed time t passes the first elapsed time ST1 until a time point Tf when the elapsed time t reaches the second elapsed time ST2. The “release” of the braking force between the time point Td until the time point Tf reduces a nose dive of the vehicle when it comes to a stop. As a result, the release enables stopping of a vehicle with a small change in the vehicle body posture, that is, with a small shock.

Driving of the hydraulic braking apparatus 2 to increase and decrease the pressure from the time point Td until the time point Tf may be executed for the four wheels. Added to that, driving as above may be executed only for the two front wheels.

At the time point Tf, when the elapsed time t exceeds the second elapsed time ST2, locking of the PKB 3 is executed (at 680). In the drawing, the braking force of the PKB 3 is shown by a line with a leading edge that was a certain gradient since the braking force is not instantly generated. As described above, after the PKB 3 is driven to be locked, the braking force of the PKB 3 is maintained due to its mechanism, even when the signal for driving the PKB 3 so as to lock is canceled. The braking force is not released until a release signal is output next.

From the time point Tf and after, even if a braking force is generated by the PKB 3, the braking force of the hydraulic braking apparatus 2 is not released. The braking force of the hydraulic braking apparatus 2 is maintained until a time point Tg when the elapsed time t has reached a third elapsed time ST3. When the driving of the hydraulic braking apparatus 2 is canceled at the time point Tg (that is, when all operation signals are turned OFF), the W/C pressure for each wheel gradually decreases until the braking force becomes zero. However, the braking force generated by the PKB 3 is maintained unless a cancel signal is input, even after a driving signal for locking is released.

As described above, the automatic braking apparatus according to the first embodiment responds to the decreased awareness level of the driver reflecting the driving operation and the movement of the line of the sight when the driver becomes unable to drive because the driver has dozed off or lost a level of consciousness. In this case, the automatic braking apparatus increases and decreases the braking force applied to each wheel intermittently or cyclically so as to generate vibration in the vehicle body. Accordingly, this vibration awakens the driver whose level of consciousness is low (in the awakening braking mode).

The method for increasing and decreasing the braking force in the awakening braking mode may be changed in accordance with the magnitude of the awareness level. For example, when the degree of decrease in the awareness level is small, that is, the awareness level of the driver is medium, both the range of increase and decrease and the cycle of repetition of increase and decrease are made smaller. On the other hand, when the degree of decrease in the awareness level is large, that is, that awareness level of the driver is low, or the minimum, both the range of increase and decrease and the cycle of repetition of increase and decrease are made larger. Accordingly, a driver awakening effect may be enhanced in accordance with the awareness level.

Moreover, the automatic braking apparatus according to the first embodiment changes the awakening braking mode to the automatic vehicle stop mode, in the case that the awareness level of the driver is not enhanced even after the intermittent or cyclic increase and decrease of the braking force is executed. Next, the hydraulic braking apparatus 2 is gradually driven to increase the pressure so as to decelerate the vehicle slowly. This allows stopping of the vehicle free from shock. Further, after the vehicle has stopped, braking by the hydraulic braking apparatus 2 is switched to braking by a motor-driven parking brake. Therefore, when the driver is continuously in a state in which the driver is unable to perform a driving operation, the automatic braking apparatus automatically stop the vehicle slowly and without causing a shock. Moreover, after the vehicle is stopped, the braking force is maintained for a long period of time without any electric energy being required.

### Second Embodiment

Next, a second embodiment will be explained. The second embodiment differs from the first embodiment with respect to the point that the braking conditions during the awakening control are corrected in accordance with a running condition of the vehicle in the awakening braking mode. The braking conditions during the awakening control are the braking force provision conditions of the awakening brake mode. As in the first embodiment, the braking force provision conditions of the awakening brake mode are calculated and selected in accordance with the awareness level. Hereafter, only difference from the first embodiment will be explained, and explanation of other structural elements and flow of processing that are the same as the first embodiment will be omitted.

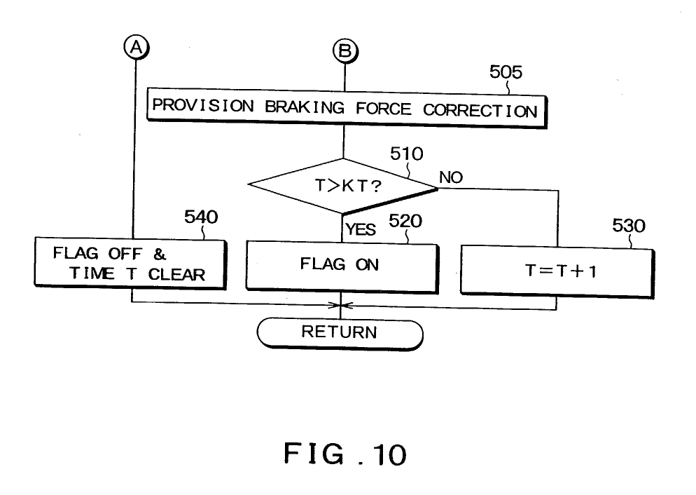

FIG. 10 is a flow chart of a section of the awakening braking mode of the second embodiment in which different processing from that of the first embodiment is executed. This figure shows only a portion that continues from the flow chart as shown in FIG. 6. Note that in FIG. 10, the same processing as the first embodiment are denoted by the same reference numerals, and thus the explanation thereof will be omitted.

Processing from 430 to 450 as shown in FIG. 6, a provision condition for increasing and decreasing the braking force is selected. Subsequently at 505, the thus selected braking force provision conditions are assumed as reference values, called a reference provision braking force and a reference provision period. They are corrected as follows.

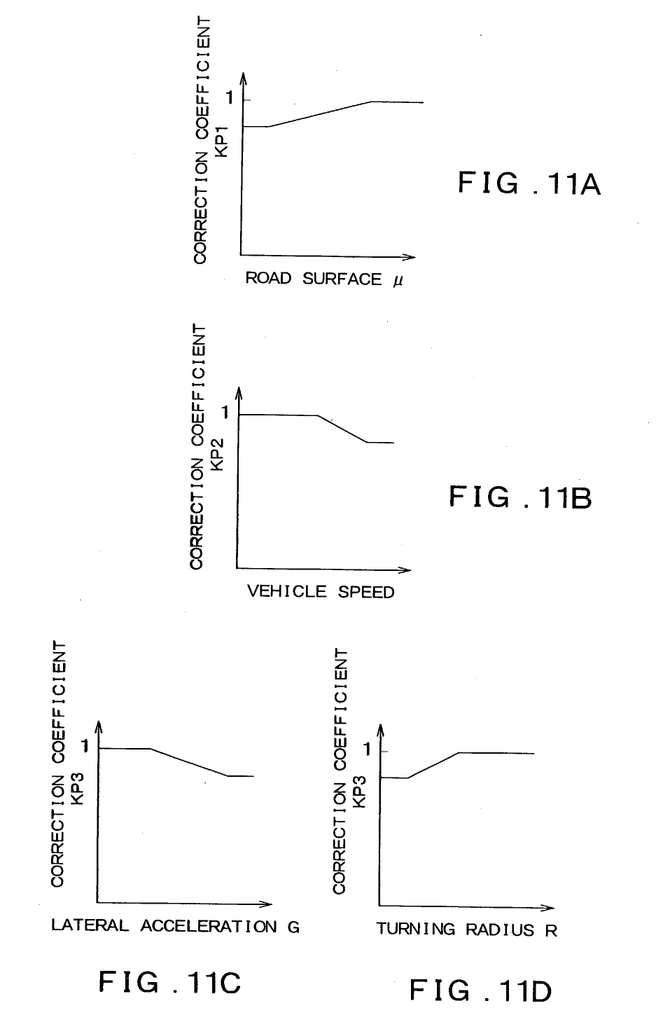

The provision braking force is corrected by multiplying the reference provision braking force of each of correction coefficients that have been predetermined according to a road surface μ, a vehicle speed and a lateral acceleration G (or a turning radius). The correction coefficients have been predetermined in the form of a map as shown in FIGS. 11A to 11C. A correction coefficient KP1 increases from a value less than 1 to 1 as the road surface μ becomes larger (that is, the road surface becomes less slippery). A correction coefficient KP2 decreases from 1 to a value less than 1 as the vehicle speed becomes larger. A correction coefficient KP3 decreases from 1 to a value less than 1 as the lateral acceleration becomes larger (when the vehicle is turning sharply). Meanwhile, the correction coefficient KP3 may be predetermined such that it increases from a value less than 1 to 1, as the turning radius R becomes larger, as shown in FIG. 11D, in place of the lateral acceleration.

Using the correction coefficients KP1 to KP3, the provision braking force and the provision period are corrected based on Equations 2 and 3.

Provision braking force=Reference provision braking force×KP1×KP2×KP3 (2)

Provision period=Reference provision period×KP1×KP2×KP3 (3)

Accordingly, the provision braking force is corrected with respect to the reference provision braking force. The provision braking force becomes smaller: as the road surface μ becomes smaller; as the vehicle speed becomes larger; or as the lateral acceleration G becomes larger (or as the turning radius R becomes smaller). The provision period is also corrected with respect to the reference provision period. The provision period becomes shorter: as the road surface μ becomes smaller; the vehicle speed becomes larger; or as the lateral acceleration G becomes larger (or as the turning radius R becomes smaller).

The aforementioned road surface μ, the vehicle speed, and the lateral acceleration G (or the turning radius R) are detected or calculated in the same manner as the first embodiment.

Processing from 510 to 530, an awakening braking control is executed by increasing and decreasing the braking force for all four wheels as an all-wheel braking mode based on the braking force provision condition corrected at 505. In the first embodiment, one of two methods is selected among applying the awakening brake either only to the front wheels, and applying to the left wheels and the right wheels alternately. This selection is made based on the magnitude of the road surface μ, the vehicle speed, and the lateral acceleration G (or the turning radius R). The all-wheel braking mode in the second embodiment is executed in place of either of the above two methods in the first embodiment.

At 540, the same processing as the first embodiment is executed.

In the second embodiment, the conditions for increasing and decreasing the braking force, that is, the provision braking force and the provision period, are corrected in accordance with the degree of the road surface μ, the vehicle speed, and the lateral acceleration G (or the turning radius R) as the running state. Therefore, a method for increasing and decreasing the braking force with a high driver awakening effect suited to the running condition is achieved.

### Modifications

The aforementioned embodiments may be modified in various ways as follows.

(1) In the first and second embodiments, the provision pattern of increasing and decreasing the braking force in the awakening braking mode was explained as a triangle wave pattern as shown in FIG. 9. However, the provision pattern is not limited to the above. Instead, it may be a rectangular wave form or the like, constituted by a repetition of increase and decrease of braking force in a stepped manner. Further, the provision pattern may resemble a saw-tooth wave form in which an increase gradient and a decrease gradient are different from each other.

(2) As in the aforementioned embodiments, the pattern of increasing and decreasing the braking force in the awakening braking mode may be cyclical, that is, the pattern may repeat with a constant cycle period. However, the provision pattern is not limited to this. Instead, a repetition period may be long immediately after a start of the awakening braking mode, and the repetition period may become gradually shorter as time elapses. Further, the repetition period may be changed randomly (so as to have irregular periods), as time elapses in the awakening braking mode. This random characteristic may have a 1/f fluctuation characteristic (f: frequency).

(3) In the first embodiment, as examples of a method for providing an awakening braking for each wheel, ON-OFF braking of only the two front wheels (in the front-wheel braking mode), or alternate braking of the two left wheels and two right wheels (alternate execution of the left-wheel braking mode and the right-wheel braking mode) were suggested. However, the provision method is not limited to this. Instead, the provision method may be based on ON-OFF braking of only the two rear wheels (in the rear-wheel braking mode) or alternate braking of the two front wheels and the two rear wheels (i.e., alternate execution of the front-wheel braking mode and the rear wheel braking mode). Alternatively, ON-OFF braking may be executed for all four wheels simultaneously (in the all-wheel braking mode). Further, ON-OFF braking may be executed for only two wheels that are diagonally positioned. That is, it may be executed for only the front-right wheel and the rear-left wheel, or for the front-left wheel and the rear-right wheel. Moreover, even when the ON-OFF braking is executed on all four wheels, braking may be increased and decreased with a time lag between the two front wheels and the two rear wheels.

(4) An awakening braking pattern may be created by combining elements in each of (1) to (3) above as appropriate. However, it is essential that any awakening braking pattern effectively awakens the driver by generating unexpected vibrations in the vehicle body, also ensuring driving safety.

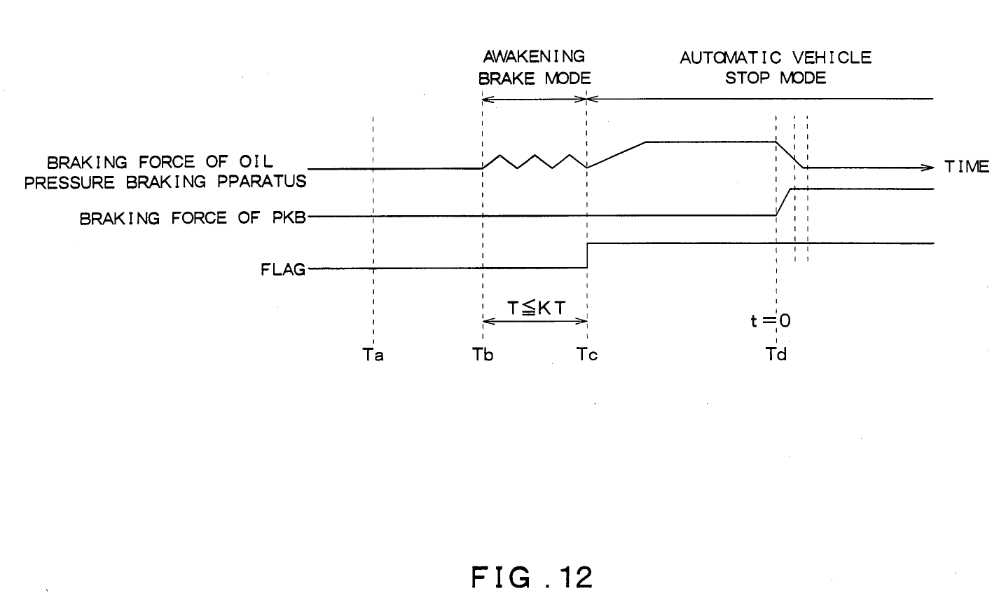

(5) In the method for reducing shock caused by braking when stopping the vehicle using the shock reducing portion in the embodiments, the braking force generated by the hydraulic braking apparatus 2 increases after it is once decreased. This allows switching of the generation mechanism of the braking force from the hydraulic braking apparatus 2 to the PKB 3 after the vehicle has been stopped. However, the method for reducing the shock is not limited to this. The braking force of the hydraulic braking apparatus 2 is not necessarily decreased. Instead, as shown in the time diagram in FIG. 12, the braking force of the hydraulic braking apparatus 2 need not be released, and may be used in combination with the braking force of the PKB 3.

The processing in FIG. 12 from a time point Ta at which the driver becomes unable to execute driving operation until a time point Td at which the vehicle is determined to have been stopped is the same as FIG. 9. In FIG. 12, when the vehicle is determined to have been stopped at the time point Td, the hydraulic braking apparatus 2 is driven so as to decrease the pressure with a gentle gradient until the braking force becomes zero. At the same time, the PKB 3 is driven to be locked so as to generate braking force relatively gently.

In other words, it is possible to reduce shock caused by braking during the vehicle is stopping, in the same manner as the other embodiments, by decreasing the braking force of the hydraulic braking apparatus 2 when the vehicle has been stopped, and increasing the braking force of the PKB 3 simultaneously.

In this case, driving of the hydraulic braking apparatus 2 so as to decrease the pressure may be executed for all four wheels. This may also be executed for only the two front wheels.

(6) In each of the embodiments, the driver's eye sensor 86 is used as a sensor detecting an operation of the driver in order to calculate and detect the awareness level. The sensor that is used for detecting the operation of the driver is not limited to the driver's eye sensor 86. Instead, a blinking sensor for detecting blinking of the driver may be used. As in the case of the driver's eye sensor 86, an image processing apparatus is used for detecting blinking. The image processing apparatus captures an image of an eyeball or an eyelid from an image of the face of the driver. Then blinking movement is detected by a change in an area of the eyeball or an area of the eyelid. Based on the frequency of blinking or the degree of opening of the eyelid, which is computed from this blinking movement, the awareness level of the driver can be calculated.

While the above description is of the preferred embodiments of the present invention, it should be appreciated that the invention may be modified, altered, or varied without deviating from the scope and fair meaning of the following claims.

What is claimed is:

1. An automatic braking apparatus, comprising:
an awareness level detection portion for detecting an awareness level of a driver;
a braking portion for providing a braking force for each wheel of a vehicle; and
a control portion for executing an awakening braking mode in which a repeated increase and decrease of the braking force is performed under a certain provision condition by controlling the braking portion when the detected awareness level is determined to be low.

2. The automatic braking apparatus according to claim 1, wherein
the provision condition in the awakening braking mode includes a provision braking force that defines the braking force that is subject to the repeated increase and decrease, and a provision period that defines a period of the repeated increase and decrease.

3. The automatic braking apparatus according to claim 2, wherein
the provision condition in the awakening braking mode further includes a braking cycle that defines a cycle of the repeated increase and decrease.

4. The automatic braking apparatus according to claim 2, wherein
the control portion sets the provision period to be longer when the awareness level is low.

5. The automatic braking apparatus according to claim 2, wherein
the control portion executes an automatic vehicle stop mode that automatically decelerates or stops the vehicle, when the detected awareness level is determined to be low after the provision period has elapsed.

6. The automatic braking apparatus according to claim 1, wherein
the control portion executes the repeated increase and decrease of the braking force for one of the provision period and a period during which the awareness level is determined to be low, whichever is shorter.

7. The automatic braking apparatus according to claim 3, wherein
the control portion changes the braking cycle such that it becomes shorter as time elapses.

8. The automatic braking apparatus according to claim 1, wherein
the control portion executes an all-wheel braking mode that repeatedly increases and decreases the braking force that is generated at all wheels of the vehicle.

9. The automatic braking apparatus according to claim 1, wherein
the control portion executes one of a front-wheel braking mode and a rear-wheel braking mode, wherein the front-wheel braking mode repeatedly increases and decreases the braking force that is generated at front wheels of the vehicle, and the rear-wheel braking mode repeatedly increases and decreases the braking force that is generated at rear wheels.

10. The automatic braking apparatus according to claim 1, wherein
the control portion alternately executes one of a front-wheel braking mode and a rear-wheel braking mode, wherein the front-wheel braking mode repeatedly increases and decreases the braking force that is generated at front wheels of the vehicle, and the rear-wheel braking mode repeatedly increases and decreases the braking force that is generated at rear wheels.

11. The automatic braking apparatus according to claim 1, wherein
the control portion alternately executes one of a left-wheel braking mode and a right-wheel braking mode, wherein the left-wheel braking mode repeatedly increases and decreases the braking force that is generated at left-side front and rear wheels of the vehicle, and the right-wheel braking mode repeatedly increases and decreases the braking force that is generated at right-side front rear wheels.

12. The automatic braking apparatus according to claim 1, further comprising:
a running state detection portion for detecting a running state of the vehicle, wherein
the control portion changes the provision condition based on information indicating the detected running state.

13. The automatic braking apparatus according to claim 12, wherein
the running state detection portion detects at least one of a coefficient of friction of a road surface, a speed of the vehicle, and a lateral acceleration of the vehicle, as the running state.

14. The automatic braking apparatus according to claim 1, wherein
the awareness level detection portion detects, as the awareness level, an object of which a size is determined in accordance with a frequency of a movement performed by the driver.
